(19) United States
(12) Patent Application Publication
(10) Pub. No.: US 2014/0236697 A1
(43) Pub. Date: Aug. 21, 2014

(54) MANAGING DIGITAL COUPONS

(71) Applicant: KT CORPORATION, Gyeonggi-do (KR)

(72) Inventors: Myoung-Hee SEO, Seoul (KR); Youn-Pil JEUNG, Gyeonggi-do (KR); Sung-Chul KIM, Gyeonggi-do (KR); Ju-Young LEE, Seoul (KR); Kook HEO, Seoul (KR)

(73) Assignee: KT CORPORATION, Gyeonggi-do (KR)

(21) Appl. No.: 14/184,957

(22) Filed: Feb. 20, 2014

(30) Foreign Application Priority Data
Feb. 20, 2013 (KR) 10-2013-0018100

(51) Int. Cl. G06Q 30/02; G06Q 20/34; G06K 7/10

(52) U.S. Cl. CPC G06Q 30/0238; G06K 7/10366; G06Q 20/346
USPC 705/14.26; 235/380

(57) ABSTRACT

Described embodiments provide a device for storing and managing a coupon in a smart card. Such a device may include a receiver, a sensor, a writer, and a reader. The receiver may be configured to receive at least one of a write request and a read request from a user where the read request is for reading a selected coupon from the smart card and the write request is for writing a selected coupon the smart card. The sensor may be configured to sense a near field communication (NFC) tag included in a smart card when the smart card is located within a predetermined distance from the device. The writer may be configured to store coupon data of a selected coupon in the smart card in response to the write request. The reader may be configured to read coupon data stored in the smart card in response to the read request. The smart card may be a combi card capable of radio frequency communication with other entities.

### CROSS REFERENCE TO PRIOR APPLICATIONS

The present application claims priority under 35 U.S.C. §119 to Korean Patent Application No. 10-2013-0018100 (filed on Feb. 20, 2013), which is hereby incorporated by reference in its entirety.

The subject matter of this application is related to U.S. patent application Ser. No. 13/949,657 filed Jul. 24, 2013, as Attorney Docket No.: (801.0103), U.S. patent application Ser. No. 14/180,843 filed Feb. 14, 2014, as Attorney Docket No.: (801.0131), U.S. patent application Ser. No. 14/167,272 filed Jan. 29, 2014, as Attorney Docket No.: (801.0125), U.S. patent application Ser. No. 14/180,767 filed Feb. 14, 2014, as Attorney Docket No.: (801.0127), and U.S. patent application Ser. No. 14/161,934 filed Jan. 23, 2014, as Attorney Docket No.: (801.0132), the teachings of which are incorporated herein their entirety by reference.

### BACKGROUND OF THE INVENTION

The present disclosure relates to a digital coupon and, more particularly, to storing and managing a digital coupon in a plastic smart card using user equipment supporting near field communication.

A contactless smart card is any pocket-sized card embedded with an integrated circuit (IC) chip capable of storing various types of digital information. Such smart card may be referred to as a chip card or an IC card. The smart card contains more information than a typical magnetic stripe card and can be programmed for different types of applications. Some cards contain programming and data to support multiple applications and some might be updated to add new applications after they are issued. Such a smart card may be referred to as a combi smart card. In general, the combi smart card includes a magnetic band, a contact IC, and a contactless chip on boards (COB) with a radio frequency (RF) antenna. The combi smart card may interact with a corresponding user terminal through the magnetic band or the contact IC in a contact interaction manner or through the contactless COB in a contactless interaction manner. Due to many advantages thereof, the combi smart card has been popularly used as a contactless payment card or a contact payment card, such as a credit card, a debit card, an identification card, an automated teller machine (ATM) card, and a payment card for public transportation.

### SUMMARY OF THE INVENTION

This summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments of the present invention overcome the above disadvantages and other disadvantages not described above. Also, the present invention is not required to overcome the disadvantages described above, and an embodiment of the present invention may not overcome any of the problems described above.

In accordance with one aspect of the present invention, a coupon may be digitally stored in a plastic smart card supporting radio frequency (RF) communication.

In accordance with another aspect of the present invention, a digital coupon may be issued at a plastic smart card.

In accordance with still another aspect of the present invention, a digital coupon stored in a plastic smart card may be used to make a payment.

In accordance with yet another aspect of the present invention, a coupon may be stored in a NFC tag applet based on NFC standards defined by the NFC forum.

In accordance with yet another aspect of the present invention, a user may be allowed to store a coupon in a smart card (e.g., a combi-card) using a smart phone and to use the stored coupon to make a payment with a payment instrument stored in the smart card.

In accordance with at least one embodiment, a device may be provided for storing and managing a coupon in a smart card. Such a device may include a receiver, a sensor, a writer, and a reader. The receiver may be configured to receive at least one of a write request and a read request from a user where the read request is for reading a selected coupon from the smart card and the write request is for writing a selected coupon the smart card. The sensor may be configured to sense a near field communication (NFC) tag included in a smart card when the smart card is located within a predetermined distance from the device. The writer may be configured to store coupon data of a selected coupon in the smart card in response to the write request. The reader may be configured to read coupon data stored in the smart card in response to the read request. The smart card may be a combi card capable of radio frequency communication with other entities.

The writer may be configured to transmit a command for selecting the sensed NFC tag applet, a command for selecting a data file of the sensed NFC tag applet, and a command for storing coupon data in the selected data file. The coupon data may include a coupon identifier (ID), a place identifier (ID), a valid period, a uniform resource locator (URL), and a mobile code (mcode). The writer may be configured to convert the selected coupon data in a NFC exchange data format (NEDF) and to encrypt at least one part of the coupon data.

The reader may be configured to transmit a command for selecting the sensed NFC tag applet, a command for selecting a data file of the sensed NFC tag applet, and a command for reading coupon data stored in the selected data file. The reader may be configured to decode at least one part of the coupon data.

In accordance with at least one embodiment, a method may be provided for storing and managing a coupon in a smart card using a device supporting near field communication. The method may include receiving at least one of a read request and a write request from a user, where the read request is for reading a selected coupon from the smart card and the write request is for writing a selected coupon the smart card, sensing a near field communication (NFC) tag applet included in a smart card when the smart card is located within a predetermined distance from the device, writing coupon data of the selected coupon in a data file of the sensed NFC tag applet in response to the write request, reading coupon data of the selected coupon from a data file of the sensed NFC tag applet in response to the read request, and displaying the read coupon data on a display of the device.

In accordance with at least one embodiment, a method may be provided for issuing and processing a coupon by a payment terminal. The method may include receiving a request for using a coupon stored in a smart card from a user, reading coupon data from a data file of a near field communication (NFC) tag applet in the smart card in response to the request, validating the read coupon data, obtaining a payment instrument from a payment instrument applet included in the same smart card, and processing a payment using the obtained payment instrument with the read coupon data applied.

The method may further include sensing a smart card upon generation of a predetermined event and writing coupon data of a predetermined coupon in a data file of a NFC tag applet of the sensed smart card. The predetermined event may be the completion of processing a payment with a payment instrument stored in a payment instrument applet of the same smart card.

### BRIEF DESCRIPTION OF THE DRAWINGS

The above and/or other aspects of the present invention will become apparent and more readily appreciated from the following description of embodiments, taken in conjunction with the accompanying drawings, of which:

FIG. 1 illustrates user equipment in accordance with at least one embodiment;

FIG. 2 illustrates a smart card in accordance with at least one embodiment;

FIG. 3 illustrates a data format of a coupon stored in a smart card in accordance with at least one embodiment;

FIG. 4 illustrates a device for storing and managing a coupon in a smart card in accordance with at least one embodiment;

FIG. 5 is a flowchart illustrating a writing operation for writing coupon data in a smart card using user equipment in accordance with at least one embodiment;

FIG. 6 is a flowchart illustrating a reading operation for reading a coupon stored in a smart card using user equipment in accordance with at least one embodiment;

FIG. 7 illustrates a method for managing a coupon in a smart card using user equipment in accordance with at least one embodiment;

FIG. 8A illustrates a writing operation for writing coupon data in a smart card in accordance with at least one embodiment;

FIG. 8B illustrates an operation for reading coupon data from a smart card in accordance with at least one embodiment;

FIG. 9 illustrates issuing a coupon in a smart card by a payment terminal in accordance with at least one embodiment;

FIG. 10 illustrates processing a payment using a coupon stored in a smart card at a payment terminal in accordance with at least one embodiment;

FIG. 11A illustrates issuing a coupon in a smart card by a payment terminal in accordance with at least one embodiment; and

FIG. 11B illustrates processing a payment using a coupon stored in a smart card at a payment terminal in accordance with at least one embodiment.

### DETAILED DESCRIPTION OF THE INVENTION

Reference will now be made in detail to embodiments of the present invention, examples of which are illustrated in the accompanying drawings, wherein like reference numerals refer to like elements throughout. The embodiments are described below, in order to explain the present invention by referring to the figures.

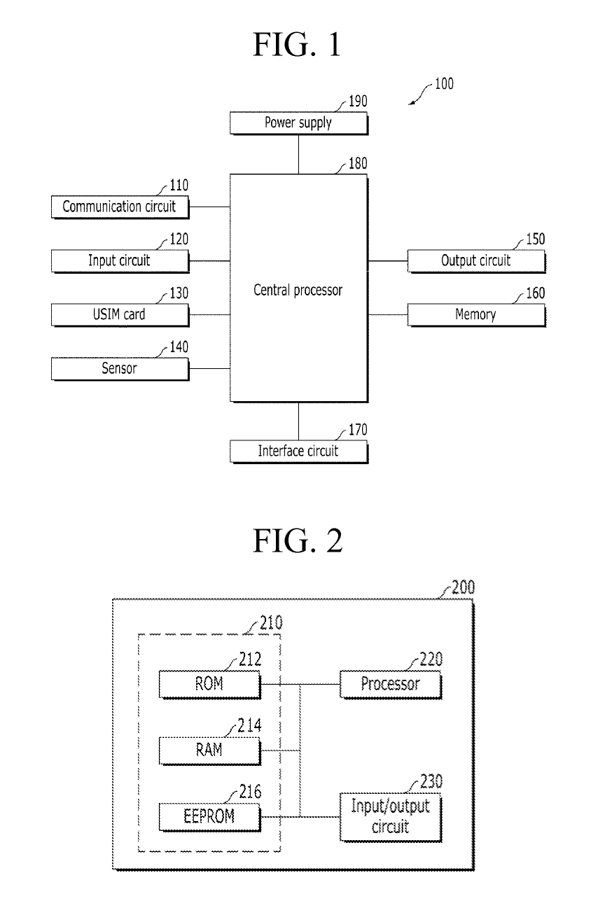

In accordance with at least one embodiment, a coupon may be digitally stored in a smart card using a device capable of near field communication (NFC) and a coupon stored in a smart card may be used to make a payment with a predetermined payment instrument stored in the same smart card. Such a device may include user equipment (e.g., a smart phone) and a payment terminal (e.g., a point-of-sale (POS) terminal). Hereinafter, as an example of the device, the configuration of user equipment will be described with reference to FIG. 1

FIG. 1 illustrates user equipment in accordance with at least one embodiment.

Referring to FIG. 1, user equipment 100 may be used to store a digital coupon in a smart card (e.g., combi card) and to read the stored digital coupon from the smart card. Furthermore, user equipment 100 may be used to download a digital coupon from a server of a merchant or from other user equipment or to make a payment for a good or a service using a coupon stored in the smart card with a payment instrument stored in the same smart card. Such user equipment 100 may be any electronic device capable of near field communication. For example, user equipment 100 may include a smartphone, a laptop computer, a personal digital assistant (PDA), a portable multimedia player (PMP), a navigation device, and a payment terminal. The present invention, however, is not limited thereto.

User equipment 100 includes communication circuit 110, input circuit 120, universal subscriber identity module (USIM) card 130, sensor 140, output circuit 150, memory 160, interface circuit 170, central processor 180, and power supply 190. However, the present invention is not limited thereto.

Communication circuit 110 may include at least one module for communicating with other party through a wireless communication system. For example, wireless communication unit 110 may include any or all of a broadcasting signal receiving module, a mobile communication module, a wireless internet module, a short-distance communication module, and a location information module (e.g., GPS receiving module). The short-distance communication module may include a Bluetooth circuit, a radio frequency identification (RFID) circuit, an infrared data association (IrDA) circuit, an ultra-wideband (UWB) circuit, a Zigbee circuit, and a near field communication (NFC) module circuit. In accordance with at least one embodiment, such a short-distance communication module may be used to communication a smart card for storing a digital coupon in the smart card and for reading a digital coupon stored in the smart card.

Input circuit 120 may be a user interface for receiving input (e.g., user commands) from a user. Input unit 120 may be realized in various types. For example, input unit 130 may include a touch screen, a keyboard and/or a keypad, a mouse device and/or a touchpad. Input unit 120 may further include a dome switch, a jog wheel, and a jog switch, but is not limited thereto. Particularly, with respect to the touch screen, user equipment 100 may be a full touch type smart phone. In this case, input unit 120 may include several hardware key buttons and a touch screen. The hardware key buttons may include a hold key and a volume control button. The touch screen may be disposed on an upper surface of output circuit 150, but the present invention is not limited thereto.

USIM card 130 may be an identification module circuit that stores information for authenticating a use right. In FIG. 1, USIM card 130 is illustrated as an identification module, but the present invention is not limited thereto. As the identification module, a user identify module (UIM) or a subscriber identity module (SIM) may be included in user equipment 100. USIM card 130 may be a smart card including a memory with a USIM module circuit in accordance with at least one embodiment. USIM card 130 may further include a NFC chip and may be referred to as a NFC USIM card. Such USIM card 130 may be coupled to user equipment 100 through interface circuit 170.

Sensor 140 may detect a current status of user equipment 100. Sensor 140 may include a variety of sensors such as a luminance sensor, an acceleration sensor, a gyro sensor, a proximity sensor, a contact sensor, and so forth. Based on the detected status of user equipment 100, sensor 140 may generate a sensing signal to control the operation of user equipment 100.

Output circuit 150 may be an output device for visually displaying information. For example, output circuit 150 may display image data produced or processed by central processor 180. Output unit 150 may receive the image data from central processor 180 and display the received image data. The image data may be produced as a result of certain operations performed by any software programs installed in user equipment 100. For example, the image data may be data processed for displaying a graphic user interface produced by an operation system and applications, performed in user equipment 100. The applications may be referred to as “App”. Also, the image data may further include still images and moving images, produced or processed by central processor 180. For example, output circuit 150 may be a liquid crystal display (LCD) panel or an active-matrix organic light-emitting diode (AMOLED) panel, but the present invention is not limited thereto.

For example, output circuit 150 may display a coupon downloaded from a related server or from other user equipment in order to enable a user to store the coupon in a smart card. Furthermore, output circuit 150 may display coupon data received from other through communication circuit 110. In addition, output circuit 150 may further include output devices for outputting auditory sensing information and haptic sensing information. For example, output circuit 150 may include a speaker, an alarm circuit, and a haptic circuit.

Memory 160 may be used as a data storage device of user equipment 100. Memory 160 may store information necessary for operating user equipment 100 and performing certain operations requested by a user. Such information may include any software programs and related data. Memory 160 may be a flash memory, hard disk, multimedia card micro memory, SD or XD memory, Random Access Memory (RAM), Static Random Access Memory (SRAM), Read-Only Memory (ROM), Programmable Read-Only Memory (PROM), Electrically Erasable Programmable Read-Only Memory (EEPROM), magnetic memory, magnetic disk, or optical disk, but is not limited thereto.

Interface circuit 170 may include at least one port for exchanging signals and/or data with others. Interface circuit 170 receives data or power from external devices and delivers the received data or power to constituent elements in user equipment 100. Furthermore, interface circuit 170 transmits data to external devices. For example, interface circuit 170 may include a wired/wireless headset port, a power charge port, a wired/wireless data port, a memory card port, and a port coupled to an identification module.

Central processor 180 may control overall operation of the constituent elements of user equipment 100. Particularly, controller 180 may perform operations necessary for driving the constituent elements of user equipment 100 in response to inputs received from a related user. In accordance with at least one embodiment, central processor 180 may perform operations related to store coupon data in a smart card or to read coupon stored in a smart card. Power supply 190 may supply power to constituent elements in response to control of central processor 180.

As described, user equipment 100 may store a digital coupon in a smart card or read a digital coupon stored in a smart card in response to a user input in accordance with at least one embodiment. Hereinafter, such a smart card will be described with reference to FIG. 2.

FIG. 2 illustrates a smart card in accordance with at least one embodiment.

Referring to FIG. 2, smart card 200 may be capable of radio frequency (RF) communication with other entities such as user equipment 100. For example, smart card 200 may be a combi smart card capable of including various applications in an applet form at JAVA based virtual machine (VM) platform. In accordance with at least one embodiment, smart card 200 may store a plurality of digital coupons in response to a request from user equipment 100 and transmit a selected digital coupon to user equipment 100 in response to a request. Smart card 200 may include memory 210, processor 220, and input/output circuit 230.

Memory 210 may be data storage of smart card 200. Memory 210 may store information necessary for operating smart card 200 and performing certain operations requested by a use in connection with user equipment 100. Such information may include operating system programs, various types of application software (e.g., app or applet), information, and data produced as a result of performing operations. Furthermore, memory 210 may store at least one digital coupon data. Such a digital coupon may be fetched and managed by a corresponding applet (e.g., NFC tag applet). When a NFC tag applet is initiated or activated, the NFC tag applet provides information on a digital coupon (e.g., coupon data) in response to the control of processor 220.

Memory 210 may include read only memory (ROM) 212, random access memory (RAM) 214, and electrically erasable programmable (EEPROM) 216, but the present invention is not limited thereto. ROM 212 may store operation system codes of smart card 200. RAM 214 may be used as a stack or a buffer for storing data produced by operating system codes. EEPROM 216 may be configured to store data and various types of application software (e.g., applets, Apps). For example, EEPROM 216 stores at least one NFC tag applet and a corresponding data file for storing digital coupons, supported by smart card 200. In case of a combi smart card used as smart card 200, EEPROM 216 may store payment instrument applets in addition to the NFC tag applets for digital coupons. The payment instrument applets may be applets for various types of payment instruments such as a credit card, a debit card, a prepaid card, and a gift card. Particularly, the payment instrument applets may be a visa smart debit card (VSDC) or a master card chip (M/CHIP).

Processor 220 may control overall operation of smart card 200 in connection with user equipment. Particularly, processor 220 may perform operations necessary for driving the constituent elements of smart card 200 in response to the generation of predetermined events. Processor 220 may execute apps or applets stored in memory 210 and process data as a result of the execution of apps or applets upon the generation of a predetermined event.

In accordance with at least one embodiment, processor 220 may perform operations related to storing and managing information stored in memory 210 upon the generation of predetermined events. Particularly, processor 220 may perform operations for storing a digital coupon in a data file of a NFC tag applet and for reading a digital coupon stored in a data file of a NFC tag applet in response to a command transmitted from user equipment 100.

Input/output circuit 230 is configured to communicate with other entity such as user equipment (e.g., user equipment 100) or a payment terminal of a merchant. For example, input/output circuit 230 performs radio frequency (RF) communication with user equipment 100. Furthermore, input/output circuit 230 performs near field communication (NFC) between smart card 200 and user equipment 100. Particularly, input/output circuit 230 may detect user equipment 100 when user equipment 100 is located in a predetermined distance and receive signal from user equipment 100. That is, input/output circuit 230 may detect a tapping operation. The tapping operation may be a user interaction made by tapping smart card 200 on user equipment 100 or tapping user equipment 100 on smart card 200. The tapping operation may be referred to as a tagging operation. Through the tapping operation, user equipment 100 detects smart card 200 or smart card 200 detects user equipment 100. In accordance with at least one embodiment, input/output circuit 230 receives coupon data from user equipment 100 and transmits stored coupon data to user equipment 100.

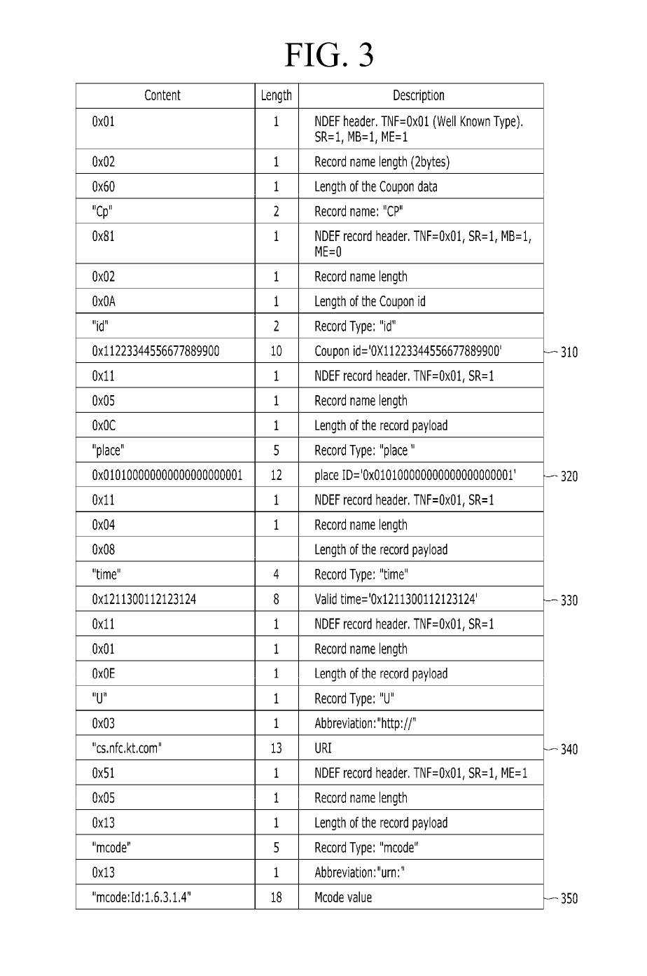

In accordance with at least one embodiment, a digital coupon may be stored in a smart card. That is, coupon data of a coupon is stored in a smart card. Such a coupon data may be created in a certain data format, for example, a NFC forum data exchange format. Hereinafter, such data format for the coupon data will be described with reference to FIG. 3.

FIG. 3 illustrates a data format of a coupon stored in a smart card in accordance with at least one embodiment.

Referring to FIG. 3, coupon record types are defined based on a NFC forum data exchange format (NDEF) to store coupons in smart card 200 in accordance with at least one embodiment. The NDEF is a data exchange format defined by the NFC Forum in order to exchange data between NFC enabled devices or a NFC enabled device and a NFC tag. Such a NDEF may be a binary message format and include capsulized payloads which are defined by at least one application in one message structure. That is, one NDEF message may have one or more NDEF records and may be used to transmit a predetermined type of a payload.

In accordance with at least one embodiment, a NDEF Type 4 tag applet may be used to store a coupon (e.g., coupon data) in smart card 200 or to read a coupon (e.g., coupon data) from smart card 200 through near field communication. Such coupon may be stored as coupon data created in a Well-Known type. For example, FIG. 3 illustrates the coupon data format defined in the Well-Known type. Such coupon data could be defined as one record type in the NFC forum similar to NDEF record types such as URI, TEXT, and Smart Poster. The present invention, however, is not limited thereto. Such coupon data may be defined as an external type.

Referring to FIG. 3, coupon data defined in a Well-known type may include coupon ID 310, Place ID 320, Valid time 330, uniform resource identifier (URI) 340, and mobile RFID code 350. Coupon ID 310 might be an identification number of a coupon. Place ID 320 may be an identification number of a place where a corresponding smart card used. For example, Place ID 320 may denote a merchant accepting a corresponding coupon. In accordance with at least one embodiment, a mobile RFID code or a mobile code (mCode) may be defined by international standard group TTA. The mobile RFID code structure and a tag data structure are well defined in TTA specifications such as TTAS.KO-06.0105/R1 (Dec. 27, 2006).

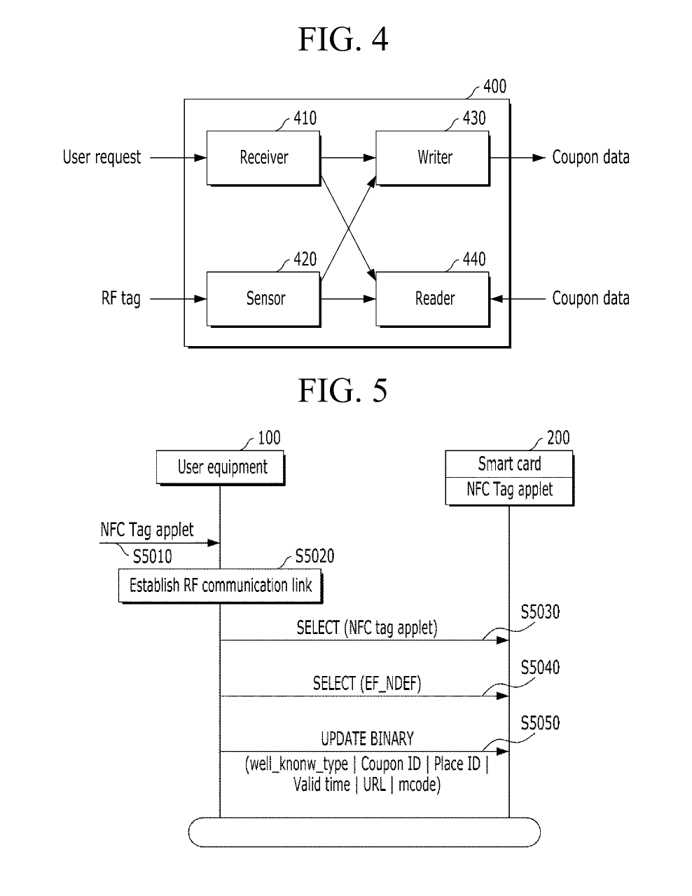

Such coupon data may be stored in a smart card or read from a smart card through a device capable of near field communication. Such a device will be described with reference to FIG. 4.

FIG. 4 illustrates a device for storing and managing a coupon in a smart card in accordance with at least one embodiment.

Referring to FIG. 4, device 400 may be implemented as hardware device such as user equipment 100 or a payment terminal (e.g., a POS terminal), but the present invention is not limited thereto. Device 400 may be implemented as an application installed in and executed by user equipment 100. Such device 400 may store a coupon selected by a user in smart card 200 or reads a coupon stored in smart card 200. Such device 400 may include receiver 410, sensor 420, writer 430, and reader 440.

Receiver 410 may receive a write request for recording a coupon in smart card 200 from a user. Such a coupon may be selected from a plurality of coupons stored in device 400 by a user. Receiver 410 may also receive a read request for reading a coupon stored in smart card 200 from a user. In accordance with at least one embodiment, a coupon may be stored in device 400 (e.g., user equipment 100 or a payment terminal) through various methods. For example, user equipment 100 may receive a coupon through a short message service (SMS) message from other entities or download a coupon from an associated server through applications stored in user equipment 100. Such application may include an electric wallet app or a coupon service app. The present invention may be not limited to a specific method for obtaining a coupon. In another embodiment, device 400 may further include a coupon downloader configured to receive or to download a coupon from other entities.

The write request and the read request may be initiated by clicking an associated icon displayed on a display of user equipment 100. For example, a coupon application for storing and managing a coupon may be installed in executed by user equipment 100. Upon the execution of the coupon application, user equipment 100 may produce and display a graphic user interface that shows a coupon image and an icon for a write request or an icon for a read request. Through such a graphic user interface, a user may activate the icon for write request for writing coupon data of the displayed coupon image to smart card 200 or activate the icon for a read request for reading coupon data stored in smart card 200. The write request may invoke a writing operation and the read request may invoke a reading operation.

Sensor 420 may sense a NFC tag applet installed in smart card 200 to perform RF communication with smart card 200 when smart card 200 comes near to device 400. For example, a user may tap smart card 200 on device 400 (e.g., user equipment 100), which may be referred to as a tapping operation. In this case, sensor 420 detects a NFC tag applet in smart card 200. That is, sensor 420 senses smart card 200 located within a predetermined distance from device 400 (e.g., user equipment 100).

Writer 430 may write coupon data of a selected coupon in a data file of a sensed NFC tag applet in response to a write request received from a user. Such coupon data may include at least one of a coupon ID, a Place ID, a valid time, a URI, and a mobile code (mcode). Write 430 may create (e.g., reconfigure) the coupon data in a NDEF in order to write the coupon data in smart card 200. For example, write 430 may generate the coupon data in a Type 4 format denoting an external type. In accordance with at least one embodiment, writer 430 may encrypt at least one part of coupon data. For example, a coupon ID and a mobile code may be encrypted for security purpose.

Writer 430 may initiate such a writing operation in response to a write request and/or a tapping operation. For example, when a user taps smart card 200 on user equipment 100 (e.g., tapping operation) and activates an icon associated with the write request for recording a coupon displayed on user equipment 100, writer 430 transmits coupon data in a NDEF format to smart card 200 with a command for recording the coupon data at the sensed NFC tag applet.

Reader 440 may read coupon data stored in a data file of a NFC tag applet sensed by sensor 420 in response to a read request from a user. After reading the coupon data from the sensed NFC tag applet, device 400 may display the read coupon data on a display (not shown).

Reader 440 may initiate such a reading operation in response to a read request and/or a tapping operation. For example, when a user taps smart card 200 on user equipment 100 (e.g., tapping operation) and activates an icon associated with the read request for reading a coupon from smart card 200, reader 440 transmits a command to smart card 200 to read coupon data from a NFC tag applet sensed by sensor 420. Hereinafter, such a writing operation and a reading operation will be described with reference to FIG. 5 to FIG. 8B.

FIG. 5 is a flowchart illustrating a writing operation for writing coupon data in a smart card using user equipment in accordance with at least one embodiment.

Referring to FIG. 5, at step S5010, a write request is initiated. For example, user equipment 100 receives a write request from a user. Such a request may be initiated by activating an associated icon displayed within a graphic user interface produced and displayed by a related coupon application installed in and executed by user equipment.

At step S5020, a RF communication link is established. For example, after the activation of the write request, a user taps smart card 200 on user equipment 100 or taps user equipment 100 on smart card 200. Upon the tapping operation, user equipment 100 establishes a RF communication link to smart card 200.

At step S5030, a selection command for selecting a NFC tag applet is transmitted. For example, user equipment 100 transmits, as the selection command, a command “SELECT (NFC tag applet)” to smart card 200 to select a sensed NFC tag applet.

At step S5040, a selection command for selecting a data file of the selected NFC tag applet is transmitted. For example, user equipment 100 transmits a command “SELECT (EF_NDEF)” to smart card 200 to select a data file of the sensed NFC tag applet.

At step S5050, an update command is transmitted. For example, user equipment 100 transmits coupon data with an update command “UPDATE BINARY (Well_Known_type∥coupon ID∥Place ID∥Valid time∥URI∥mcode)” to smart card 200. In response to the write command, smart card 200 writes the received coupon data in the selected data file of the selected NFC tag applet.

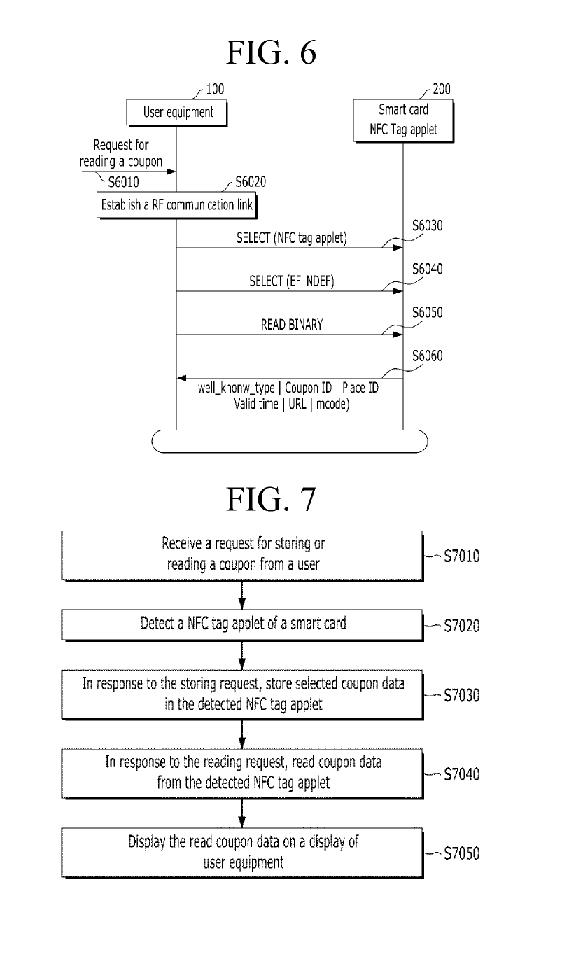

FIG. 6 is a flowchart illustrating a reading operation for reading a coupon stored in a smart card using user equipment in accordance with at least one embodiment.

Referring to FIG. 6, at step S6010, a read request is received. For example, user equipment 100 receives a read request from a user. Such a request may be initiated by activating an associated icon displayed within a graphic user interface produced and displayed by a related coupon application installed in and executed by user equipment.

At step S6020, a RF communication link is established. For example, after the activation of the read request, a user taps smart card 200 on user equipment 100 or taps user equipment 100 on smart card 200. Upon the tapping operation, user equipment 100 senses smart card 200 and establishes a RF communication link to smart card 200.

At step S6030, a selection command for selecting a NFC tag applet is transmitted. For example, user equipment 100 transmits, as the selection command, a command “SELECT (NFC tag applet)” to smart card 200 to select a sensed NFC tag applet.

At step S6040, a selection command for selecting a data file of the selected NFC tag applet is transmitted. For example, user equipment 100 transmits a command “SELECT (EF_NDEF)” to smart card 200 to select a data file of the sensed NFC tag applet.

At step S6050, a read command is transmitted. For example, user equipment 100 transmits a read command “READ BINARY” to smart card 200. In response to the read command, smart card 200 may read the coupon data stored in the selected data file of the selected NFC tag applet.

At step S6060, the read coupon data is transmitted. For example, smart card 200 transmits the coupon data of (Well_Known_type∥coupon ID∥Place ID∥Valid time∥URI∥mcode to user equipment 100 in response to the read command. After receiving, reader 440 may decode an encrypted part of the coupon data. Furthermore, user equipment 100 may display the received coupon data on a display thereof.

FIG. 7 illustrates a method for managing a coupon in a smart card using user equipment in accordance with at least one embodiment.

Referring to FIG. 7, a smart card may be a combi smart card having a NFC tag capable of RF communication. At step S7010, at least one of a write request and a read request may be received from a user. For example, user equipment 100 receives at least one of the write request and the read request in order to write coupon data in smart card 200 and read coupon data stored in smart card 200. The coupon data may include at least one of coupon ID, a place ID, a valid time, a URI, and a mobile code (mcode).

At step S7020, a NFC tag applet in a smart card is sensed. When a user taps smart card 200 on user equipment 100, user equipment 100 senses a NFC tag applet included in smart card 200. The sensing operation (e.g., S7020) is illustrated as being sequentially performed after the receiving operation (e.g., S7010), but the present invention is not limited thereto. For example, one of the write request and the read request may be received after sensing the NFC tag in smart card 200.

At step S7030, the selected coupon data is recorded in a data file of the sensed NFC tag applet in response to the write request. For example, user equipment 100 writes the coupon data of the selected coupon in a data file of the sensed NFC tag applet in smart card 200.

For example, user equipment 100 transmits a selection command for selecting a sensed NFC tag applet, a selection command for selecting a data file of the selected NFC tag applet, and an update command for writing coupon data in the selected data file to smart card 200 to write coupon data in smart card 200. That is, user equipment 100 may transmit coupon data with commands for selecting a sensed NFC tag applet, for selecting a data file thereof, and a write commend for writing the transmitted coupon data in the selected data file. In response to such commend, smart card 200 selects the sensed NFC tag applet and the data file thereof, and write the received coupon data in the selected data file.

For example, user equipment 100 may convert or reconfigure coupon data in a NDEF before transmitting coupon data to smart card 200. Furthermore, before converting or reconfiguring, user equipment 100 may encrypt a predetermined part of coupon data, such as a coupon ID or a mobile code, for security purpose.

At step S7040, coupon data may be read from a data file of the sensed NFC tag applet in response to the read request. In response to the read request, user equipment 100 reads predetermined coupon data stored in smart card 200.

For example, user equipment 100 transmits a selection command for selecting a sensed NFC tag applet, a selection command for selecting a data file of the selected NFC tag applet, and a read command for reading coupon data from the selected data file to smart card 200. In response to such command, smart card 200 selects the sensed NFC tag applet, selects the data file thereof, and read coupon data stored in the selected data file. After reading, smart card 200 transmits the coupon data to user equipment 100.

As described, at least one part of the coupon data may be encrypted for security purpose. In this case, the encrypted part of the read coupon data may be decoded before transmitting to user equipment 100.

At step S7050, the read coupon data is displayed. For example, user equipment 100 receives the coupon data from smart card 200 and displays the received coupon data on a display thereof. Furthermore, user equipment 100 may access an associated server of the received coupon based on URI information included in the coupon data and obtains detailed information from the received coupon, such as a coupon image, a discount rate, applicable merchants, and so forth.

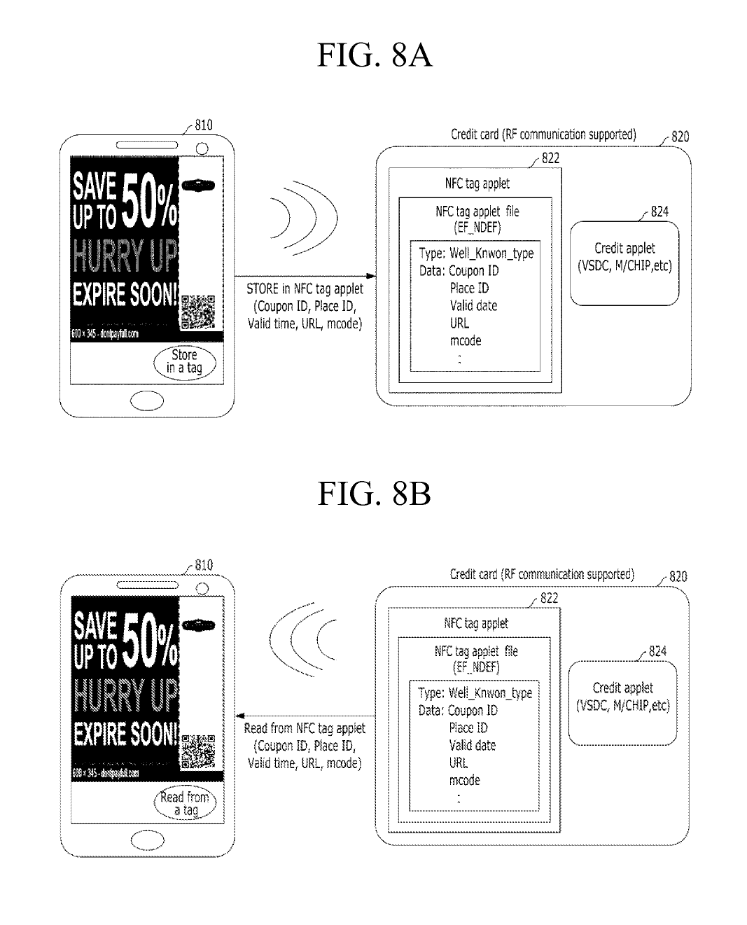

FIG. 8A illustrates a writing operation for writing coupon data in a smart card in accordance with at least one embodiment.

Referring to FIG. 8A, user equipment 810 may display a coupon with an icon for a write request. When a user activates the icon for the write request and when the user taps smart card 820 on user equipment 810, user equipment 810 generates a write request for writing the displayed coupon in smart card 820. That is, user equipment 810 transmits coupon data in a NDEF. The coupon data include a coupon ID, a place ID, a valid time, a URI, and a mobile code (mcode).

The transmitted coupon data is stored in a data file (EF_NDEF) of a NFC tag applet 822 included in smart card 820. As shown in FIG. 8A, smart card 820 is a combi card that include credit card applet 824 in addition to NFC tag applet 822.

FIG. 8B illustrates an operation for reading coupon data from a smart card in accordance with at least one embodiment.

Referring to FIG. 8B, when a user activates an icon for a read request, which is displayed on a display of user equipment 810, and when the user taps smart card 820 on user equipment 810, user equipment 810 reads coupon data in a NDEF from a data file (EF_NDEF) of a NFC tag applet 822 included in smart card 820. As described the coupon data include a coupon ID, a place ID, a valid time, a URI, and a mobile code.

As shown, user equipment 810 displays the coupon data transmitted from smart card 820. Such coupon image may be included in the coupon data or obtained from an associated server based on URL information included in the coupon data.

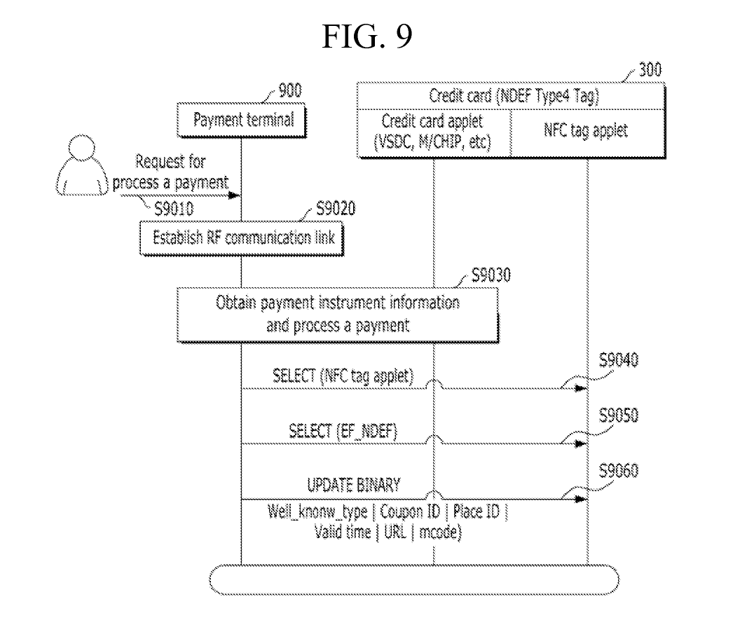

As described above, a coupon may be stored in smart card 200 by a payment terminal. Furthermore, a coupon stored in smart card 200 may be retrieved from smart card 200 by a payment terminal. Such operation of a payment terminal will be described with reference to FIG. 9 to FIG. 11B.

FIG. 9 illustrates issuing a coupon in a smart card by a payment terminal in accordance with at least one embodiment.

Referring to FIG. 9, a payment terminal may process a payment made a certain payment instrument such as a credit card or a debit card. For example, the payment terminal may include a point-of-sale (POD) terminal or a payment dongle. Smart card may be a combi card having a credit card applet and a NFC tag applet, but the present invention is not limited thereto.

As shown, payment terminal 900 receives a payment request at step S9010. Such a payment request may be made through a tapping operation that taps smart card 300 on payment terminal 900. At step S9020, payment terminal 900 establishes a communication link to smart card 300. For example, upon the tapping operation, payment terminal 900 detects smart card 300 and senses a NFC tag applet and at last one credit card applet in smart card 300. At step S9030, payment terminal 900 obtains payment instrument information (e.g., credit card information) from the credit card applet. For example, the payment instrument information (e.g., credit card information) may include a name of a credit card, a credit card number, an expiration date, a security code, an internet address of a related server, and so forth. The payment information may include information on a payment, such as a price of a good or a service, a name of a merchant, a purchase time, and so forth. Based on such payment instrument information and payment information, payment terminal 900 processes the payment made through smart card 300.

After completing the payment process, payment terminal 900 may issue a coupon (e.g., a discount coupon) to a customer (e.g., an owner of credit card 300) as reward. In order to receive the coupon, a customer may tap smart card 300 on payment terminal 900 again. Upon the tapping operation, payment terminal 900 may store coupon data of the discount coupon in a data file of a NFC tag applet of smart card 300. For example, payment terminal 900 transmits a selection command (SELECT (NFC tag applet) for selecting a sensed NFC tag applet, a selection command (SELECT (EF_NDEF) for selecting a data file of the selected NFC tag applet, and an update command (UPDATE BINARY (Well_Knwon_type∥coupon ID∥place ID∥valid time∥URI∥mcode) for writing coupon data in the selected data file to smart card 200 to write coupon data in smart card 200 at steps S9030 to S9050. In response to such command, smart card 300 selects the sensed NFC tag applet, select a data file of the sensed NFC tag applet, and write the coupon data in the selected data file of the sensed NFC tag applet.

For example, payment terminal 900 may convert or reconfigure coupon data in NDEF before transmitting coupon data to smart card 300. Furthermore, before the conversion, a part of coupon data (e.g., a coupon ID or a mobile code) may be encrypted for security purchase.

The writing operations (e.g., steps S9040 to S9060) were described for issuing a new coupon in smart card 30, but the present invention is not limited thereto. The writing operations (e.g., steps S9040 to S9060) may be performed for updating coupon data after a user used the coupon stored in smart card 300. For example, when a user used the coupon stored in smart card 300 for making a payment for a good or a service, payment terminal 900 may update the coupon data associated with the used coupon. That is, payment terminal 900 may delete the coupon data through steps S9040 to S9060 or modify the coupon data according to a used amount of the coupon. For example, when a coupon has a certain cash value and a user used a portion of the initiation cash value of the coupon, payment terminal 900 may decrease the initiation cash value of the coupon data stored in smart card 300 by performing steps S9040 to S9060.

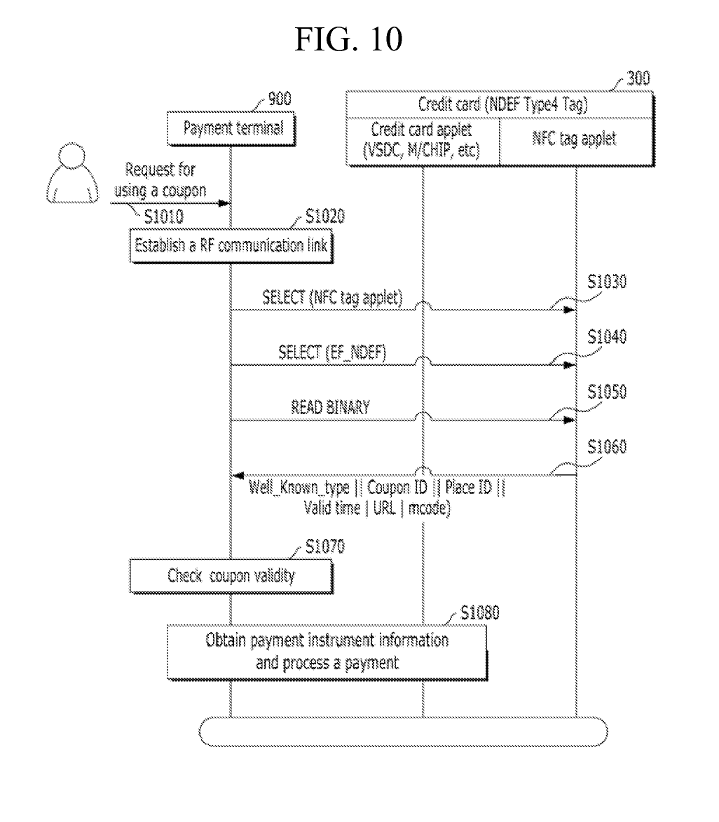

FIG. 10 illustrates processing a payment using a coupon stored in a smart card at a payment terminal in accordance with at least one embodiment.

Referring to FIG. 10, at step S1010, payment terminal 900 receives a request for using a coupon from a user. Such a request may be made through a tapping operation that taps smart card 300 on payment terminal 900 while a customer asks a clerk to use a coupon. At step S1020, a RF communication link is established. For example, upon the tapping operation, payment terminal 900 detects smart card 300 and establishes a RF communication link to smart card 300.

At step S1030, a selection command for selecting a NFC tag applet is transmitted. For example, payment terminal 900 transmits a command “SELECT (NFC tag applet)” to smart card 300 to select a sensed NFC tag applet of smart card 300. In response to such selection command, smart card 300 selects a NFC tag applet.

At step S1040, a selection command for selecting a data file of the selected NFC tag applet is transmitted. For example, payment terminal 900 transmits a command “SELECT (EF_NDEF)” to smart card 300 to select a data file of the sensed NFC tag applet. In response to the selection command, smart card selects a data file of the selected NFC tag applet.

At step S1050, a read command is transmitted. For example, payment terminal 900 transmits a read command “READ BINARY” to smart card 300. In response to the read command, smart card 300 reads coupon data stored in the selected file. At step S1060, the read coupon data is transmitted. For example, smart card 300 transmits the coupon data (e.g., Well_Known_type∥coupon ID∥Place ID∥valid time∥URI∥mcode) to payment terminal 900 in response to the read command.

At step S1070, a validity of the received coupon data is inspected. For example, payment terminal 900 inspects the validity of the received coupon data. At step S1080, payment terminal 900 obtains information on a payment instrument from the same smart card (e.g., smart card 300). That is, payment terminal 900 obtains credit card information from the credit card applet and process a payment by applying the information on the received coupon data. Payment terminal 900 may access a server issuing the coupon based on the information included in the received coupon data and validate the received coupon data in connection with the server. For example, at least one part of the read coupon data may be encrypted. In this case, the encrypted part of the read coupon data may be decoded.

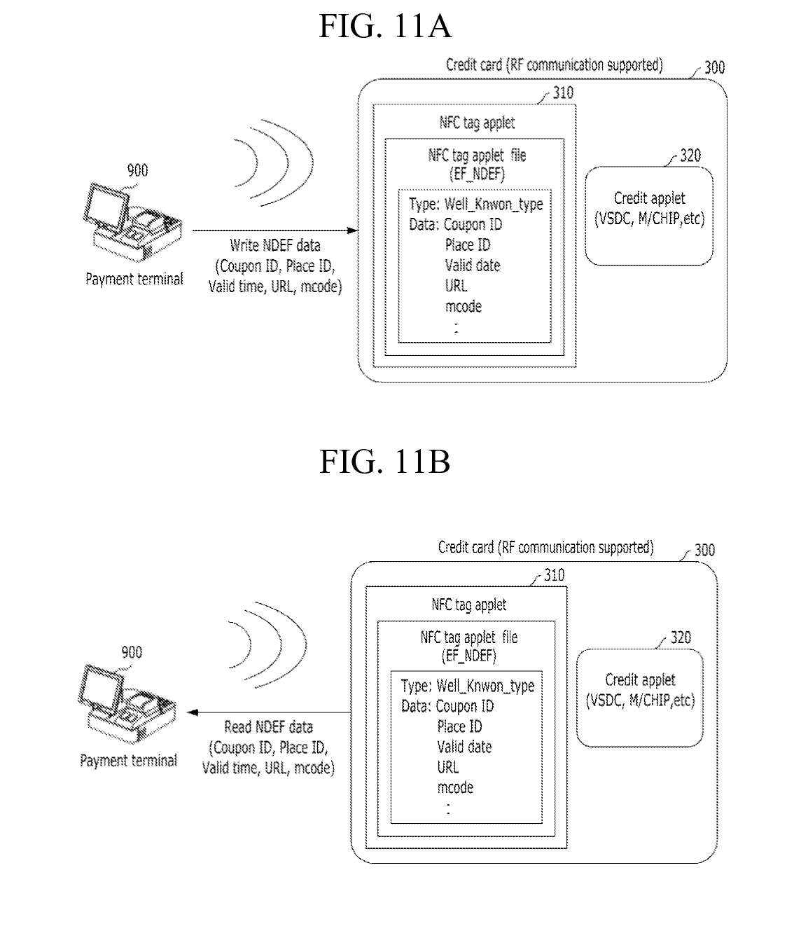

FIG. 11A illustrates issuing a coupon in a smart card by a payment terminal in accordance with at least one embodiment.

Referring to FIG. 11A, payment 900 may issues a coupon to smart card 300 after completing processing a payment made through credit card 300 in order to give reward to an associated customer. A customer may tap credit card 300 on payment terminal 900 again in order to receive a coupon. Upon the tapping operation, payment terminal 900 transmits coupon data created in a NDEF to credit card 300 with predetermined commands. The coupon data may include a coupon ID, a place ID, a valid time, a URI, and a mobile code. In response to the command, credit card 300 stores the received coupon data in a data file of a NFC tag applet.

FIG. 11B illustrates processing a payment using a coupon stored in a smart card at a payment terminal in accordance with at least one embodiment.

Referring to FIG. 11B, a customer may use a coupon stored in credit card 300 to make a payment when the customer makes a payment using credit card information stored in the same credit card 300. A customer may tap credit card 300 on payment terminal 900 in order to use a coupon stored in credit card 300. Upon the tapping operation, payment terminal 900 reads coupon data stored in a data file (EF_NDEF) of a NFC tag applet of credit card 300. Then, payment terminal 900 processes a payment using credit card information obtained from the same credit card 300 by applying the received coupon data.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present invention can be embodied in the form of methods and apparatuses for practicing those methods. The present invention can also be embodied in the form of program code embodied in tangible media, non-transitory media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

No claim element herein is to be construed under the provisions of 35 U.S.C. §112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A device of storing and managing a coupon in a smart card, comprising:
a receiver configured to receive at least one of a write request and a read request from a user where the read request is for reading a selected coupon from the smart card and the write request is for writing a selected coupon the smart card;
a sensor configured to sense a near field communication (NFC) tag included in a smart card when the smart card is located within a predetermined distance from the device;
a writer configured to store coupon data of a selected coupon in the smart card in response to the write request; and
a reader configured to read coupon data stored in the smart card in response to the read request.

2. The device of claim 1, wherein the smart card is a combi card capable of radio frequency communication with other entities.

3. The device of claim 2, wherein the writer is configured to transmit a command for selecting the sensed NFC tag applet, a command for selecting a data file of the sensed NFC tag applet, and a command for storing coupon data in the selected data file.

4. The device of claim 1, wherein the coupon data includes a coupon identifier (ID), a place identifier (ID), a valid period, a uniform resource locator (URL), and a mobile code (mcode).

5. The device of claim 4, wherein the writer is configured to convert the selected coupon data in a NFC exchange data format (NEDF).

6. The device of claim 5, wherein the writer is configured to encrypt at least one part of the coupon data.

7. The device of claim 1, wherein the reader is configured to transmit a command for selecting the sensed NFC tag applet, a command for selecting a data file of the sensed NFC tag applet, and a command for reading coupon data stored in the selected data file.

8. The device of claim 7, wherein the reader is configured to decode at least one part of the coupon data.

9. A method of storing and managing a coupon in a smart card using a device supporting near field communication, the method comprising:
receiving at least one of a read request and a write request from a user, where the read request is for reading a selected coupon from the smart card and the write request is for writing a selected coupon the smart card;
sensing a near field communication (NFC) tag applet included in a smart card when the smart card is located within a predetermined distance from the device;
writing coupon data of the selected coupon in a data file of the sensed NFC tag applet in response to the write request;
reading coupon data of the selected coupon from a data file of the sensed NFC tag applet in response to the read request; and
displaying the read coupon data on a display of the device.

10. The method of claim 9, wherein the smart card is a combi card capable of radio frequency communication to other entities.

11. The method of claim 9, wherein the writing includes:
transmitting, to the smart card, a command for selecting the sensed NFC tag applet, a command for selecting a data file of the sensed NFC tag applet, and a command for storing coupon data in the selected data file.

12. The method of claim 11, wherein the coupon data includes a coupon identifier (ID), a place identifier (ID), a valid period, a uniform resource locator (URL), and a mobile code (mcode).

13. The method of claim 12, comprising:
converting the coupon data in a NFC exchange data format (NEDF) before storing the coupon data in the smart card.

14. The method of claim 13, comprising:
encrypting at least one part of the coupon data,
wherein the at least one part include a coupon identifier (ID) and a mobile code (mCode).

15. The method of claim 9, wherein the reading includes:
transmitting, to the smart card, a command for selecting the sensed NFC tag applet, a command for selecting a data file of the sensed NFC tag applet, and a command for reading coupon data stored in the selected data file.

16. The method of claim 15, comprising:
decrypting at least one part of the read coupon data before displaying the read coupon data on the display.

17. A method of issuing and processing a coupon by a payment terminal, the method comprising:
receiving a request for using a coupon stored in a smart card from a user;
reading coupon data from a data file of a near field communication (NFC) tag applet in the smart card in response to the request;
validating the read coupon data;
obtaining a payment instrument from a payment instrument applet included in the same smart card; and
processing a payment using the obtained payment instrument with the read coupon data applied.

18. The method of claim 17, wherein the reading includes:
transmitting, to the smart card, a command for selecting the sensed NFC tag applet, a command for selecting a data file of the sensed NFC tag applet, and a command for reading coupon data stored in the selected data file.

19. The method of claim 17, wherein the validating includes:
obtaining information on a server associated with the read coupon data; and
performing the validating in connection with the associated server.

20. The method of claim 17, comprising:
sensing a smart card upon generation of a predetermined event; and
writing coupon data of a predetermined coupon in a data file of a NFC tag applet of the sensed smart card,
wherein the predetermined event is completion of processing a payment with a payment instrument stored in a payment instrument applet of the same smart card.
